(19) United States
(12) Patent Application Publication
(10) Pub. No.: US 2022/0379405 A1
(43) Pub. Date: Dec. 1, 2022

(54) Method of Laser Welding

(71) Applicant: Volvo Car Corporation, Goteborg (SE)

(72) Inventor: Urban Todal, Kungälv (SE)

(21) Appl. No.: 17/752,934

(22) Filed: May 25, 2022

(30) Foreign Application Priority Data
May 28, 2021 (EP) 21176681.1

(51) Int. Cl. B23K 26/26

(52) U.S. Cl. CPC B23K 26/26

(57) ABSTRACT

A method of joining a first and a second object, each object having a substantially flat surface. The method includes the steps of: placing the objects with their surfaces in a contacting relationship along an interface, with their surfaces substantially parallel, the interface having a peripheral edge, irradiating a laser beam with a focal point onto the peripheral edge in the direction of the interface while the plates are in a contacting relationship, and moving the focal point of the laser beam along the interface in a direction transversely to the edge, to a position at a distance from the edge.

### CROSS-REFERENCE TO RELATED APPLICATION

The disclosure claims the benefit of priority of co-pending European Patent Application No. 21176681.1, filed on May 28, 2021, and entitled “Method of Laser Welding,” the contents of which are incorporated in full by reference herein.

### TECHNICAL FIELD

The disclosure relates to a method of laser welding a first and a second object, each object having a substantially flat surface, the method including the step of placing the objects with their surfaces in a contacting relationship along an interface.

### BACKGROUND

It is known to join two metal trips in a contacting relationship by bringing the strips together between two pressure rollers. The strips are spaced apart before entering between the pressure rollers and a laser beam irradiates the strips at their point of contact prior to being pressed together to form a kissing weld.

The known method includes heavy rollers for compression of the plates and requires a relatively large footprint.

### SUMMARY

It is an object of the disclosure to provide a method of laser welding two metal objects with their surfaces in a contacting relationship, thereby obtaining a strong bond. It is a further object of the disclosure to provide a method of laser welding two objects that requires a relatively small footprint and that can be easily integrated in a production environment.

Herein, a method according to the disclosure includes the steps of:
placing the objects with their surfaces in a contacting relationship along the interface with their surfaces substantially parallel, the interface extending to a peripheral edge,
irradiating a laser beam with a focal point onto the peripheral edge in the direction of the interface while the objects are in a contacting parallel relationship, and
moving the focal point of the laser beam along the interface in a direction transverse to the peripheral edge, to a position at a distance from the edge.

The laser beam was found to penetrate a relatively long distance from the peripheral edge by melting both metals on either side of the interface while forming a strong bond of the molten metals after switching off the beam.

In an embodiment of the method according to the disclosure, the first object includes aluminum, the second object includes copper. It was found that the welding method according to the disclosure achieves a strong copper to aluminum bond that is not brittle, over a large bonding area, resulting in a strong bond.

### BRIEF DESCRIPTION OF THE DRAWINGS

An embodiment of the laser welding method will, by way of non-limiting example, be described in detail with reference to the accompanying drawings. In the drawings:

FIG. 1 shows a schematic lay-out of the laser welding method according to the disclosure,

FIG. 2 shows a side view of a laser weld formed between an aluminum and a copper strip, and

FIG. 3 shows a view of a cross-section of the weld of FIG. 2 on an enlarged scale, in a vertical orientation.

### DESCRIPTION OF EMBODIMENTS

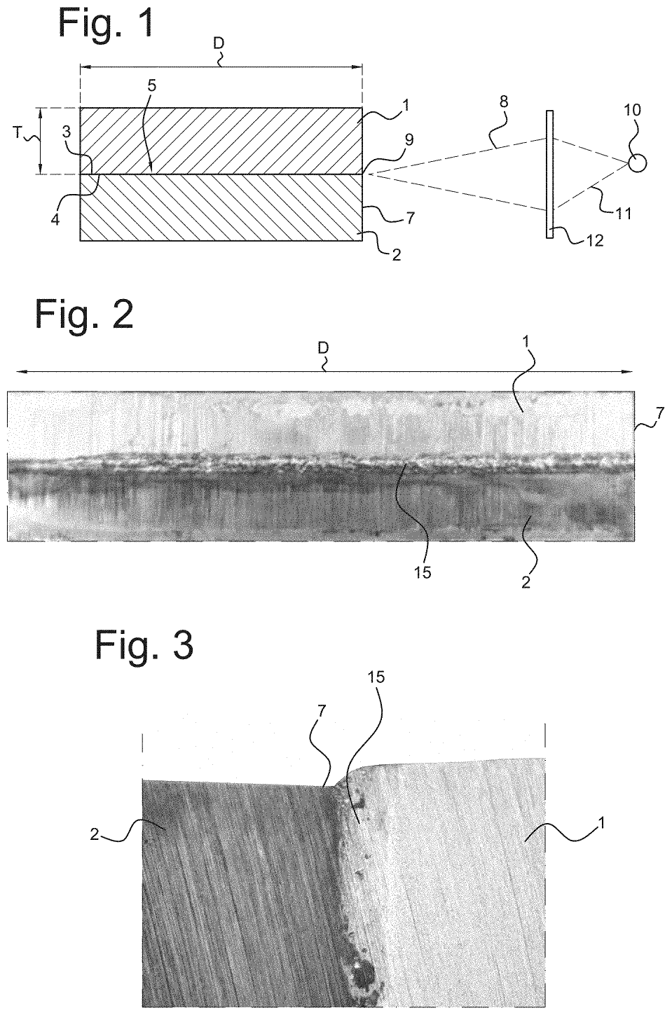

FIG. 1 shows an aluminum plate 1 and a copper plate 2, each with a substantially flat contact surface 3, 4. The surfaces 3, 4 are placed in a contacting relationship along the interface 5.

The plates 1,2 may have a thickness T of for instance 1 mm-10 mm and may be of larger thickness such as up to 20 mm and more.

A laser source 10 generates a laser beam 8 that is focused through optics 12 in a focal point 9 onto a perimeter 7 of the plates 3, 4 at the position of the interface 5. In a test set up, a copper and aluminum plate were placed, according to the disclosure, with their flat surfaces in a contacting relationship, each plate having a thickness of 3 mm. Using a Trudisk 6001 laser welding device, marketed by the Trumpf GmbH, Germany, at a Laser power of 3000 W and a focal spot diameter of 0,17 mm, the laser was irradiated onto the perimeter 7 of the stacked plates, to melt the metal surfaces on each side of the interface 5.

The focal point 9 of the laser penetrated a distance D of over 5 mm between the plates 1,2, and as long as several cm, along the interface 5, away from the perimeter 7.

FIG. 2 shows an example of the weld 15 formed along the interface 5 of an aluminum plate 1 and copper plate 15 along a length D that may be up to several cm, or longer.

FIG. 3 shows an enlarged cross-section of the weld 15, in a vertical orientation, along which a homogeneous alloy of the copper and aluminum is formed over a large surface area and a strong bond is achieved.

1. A method of joining a first object and a second object, each object having a substantially flat surface, the method comprising the steps of:
placing the objects with their surfaces in a contacting relationship along an interface, with their surfaces substantially parallel, the interface extending to a peripheral edge,
irradiating a laser beam with a focal point onto the peripheral edge in a direction of the interface while the objects are in a contacting parallel relationship, and
moving the focal point of the laser beam along the interface in a direction transverse to the peripheral edge, to a position at a distance from D the peripheral edge.

2. The method according to claim 1, wherein the first object comprises aluminum, and the second object comprises copper.

3. The method according to claim 1, wherein a dimension of the focal point of the laser beam is between 0.01 mm and 0.5 mm and the distance D from the peripheral edge is between 0.5 mm and 50 mm.

4. The method according to claim 1, wherein the power of the laser bream is at least 2500 W.
